(19) United States
(12) Patent Application Publication
(10) Pub. No.: US 2024/0277174 A1
(43) Pub. Date: Aug. 22, 2024

(54) Appliance used for slow cooking or temperature maintenance

(71) Applicant: Cindijo McDonald, West Chester, OH (US)

(72) Inventor: Cindijo McDonald, West Chester, OH (US)

(21) Appl. No.: 18/171,355

(22) Filed: Feb. 19, 2023

(51) Int. Cl. A47J 27/00; A47J 27/13; A47J 36/06

(52) U.S. Cl. CPC A47J 27/004; A47J 27/13; A47J 36/06; A47J 2202/00

(57) ABSTRACT

A thermal appliance includes a housing having an insert operably contained therein for receiving product for human consumption, the housing having an upper a stacking mating surface, a bottom mating surface complementary configured to be mated to an upper stacking mating surface of another like formed appliance, and a stand operably connected to the housing of the upwardly disposed appliance and to enable disposal on a surface below when the appliance is mated with another like appliance to maintain the upwardly disposed appliance in an elevated normal position relative to the stand.

### TECHNICAL FIELD

This invention relates generally to appliances used for slow cooking or temperature maintenance. More particularly, but not by way of limitation, the invention relates to quick connect and setup of appliances used for slow cooking or temperature maintenance.

### BACKGROUND OF THE INVENTION

Slow cooking and food warming appliances products is a significant area of interest for many cooking and entertaining consumers. These products allow for social gatherings, events, parties, family meal preparation, temperature maintenance and planning, to be more efficient less messy and organized.

In addressing the state of the art, there have been many food appliances used for maintaining temperature or cooking food. One type of these employs a pot in which cooking or warming occurs over a relatively long period of time, 8 hours in some cases, and at low temperatures, with the food submerged a removable cleanable container, i.e., a crock pot. Examples of food cooked include all types of dips, meat and fish, chicken, eggs and vegetables to name a few. Various foods may be cooked in as little as 20 minutes, up to a few hours and kept warm for many more.

A number of cooking appliances are commercially available and are suitable for home or commercial use. Some of these include dedicated stand-alone appliances, which have the disadvantage of being single-function appliances which require a lot of space on a countertop as well as for storage when not in use. Additionally, some of these can be both difficult and inconvenient as they are a fixed size, they also lack the capability to conveniently handle diverse quantities/sizes of food to be cooked.

Others lack the portability to a site or particular venue where catering may be taking place. Crock pots are commonly used for cooking a particular item and then transported to a venue for use.

While this type of appliance overcomes some of the limitations of fixed container size appliances noted above, it still has significant limitations. Crock pots currently are configured with individual use for a particular food item in mind, and thus when attending a function, the site must set up an area with many power sources to handle what might be a significant number of such appliances. This can be problem for the preparer. Additionally, table top space can be limited, such as at a tailgate party or outdoor gathering.

There is a need to provide an improvement in appliances which warm or cook This customization and innovation to this product will allow for social gatherings, events, parties, family meal preparation and planning, to be more efficient less messy and organized.

### SUMMARY OF INVENTION

It is an object to improve appliances used for slow cooking or temperature maintenance.

Another object is to provide appliances used for slow cooking or temperature maintenance in more user friendly manner.

Still another object is to provide appliances used for slow cooking or temperature maintenance in a stackable manner.

Yet another object is to provide appliances used for slow cooking or temperature maintenance in an operably connectable manner to reduce space and need for connectivity.

Accordingly, the invention is directed to an appliance, such as a slow cooker (crock pot), which includes a housing having an insert operably contained therein for receiving product for human consumption. The housing can include an upper a stacking mating surface, preferably adjacent a back of the housing. The housing can include a bottom mating surface, preferably adjacent a front of the housing, complementary configured to be mated to an upper stacking mating surface of another like formed appliance. A stand is operably connected to the housing of an upwardly disposed appliance to enable disposal on a surface below when the appliance is mated with another like appliance to maintain the upwardly disposed appliance in an elevated normal position relative to the stand while enabling proper fitment of the upper stacking mating surface and bottom mating surface. The stand can be space saving legs that extend down to allow for this appliance(s) to connect and stack the individual appliances to make a buffet or serving station for example.

The housing can preferably be equipped with a heating element for heating the insert. An electrical power inlet line extends through the housing to power the heating element, preferably in a manner which does not impede the interconnect-ability of the appliances, such as in the back of the housing. To this end, there is also provided a power outlet disposed on the housing operably connected to the electrical power inlet line for supplying power for example to an adjacent appliance. The housing can also be equipped with a power panel which can have a switch for powering on and off the appliance as well as be provided with on and off power indicator lights. Additionally, the housing can be equipped with a visible temperature indicator operably connected to the insert in a manner to display temperature therein.

In a preferred embodiment, the appliance can be a stackable a square or rectangular design, with a height dimension that allows for one or more legs to allow for stacking and linking of the individual appliances to connect to one or more units. A removable lid can preferably be provided to cover the insert and fit on top of the housing in a complementary manner. The lid can also be equipped with a handle which can preferably have a shape, such as a concave aspect, to aid in retention of a utensil, such as a spoon or fork. The lid in one embodiment is removable and configured with a thickness to seat in a groove of a portion of an upper surface of the housing and when so seated, the handle is positioned to retain the utensil. This space saving design includes placement for the lid and spoon to be held on the appliance to save space. The handle serves as both a lid holder and utensil holder as noted can be configured preferably with groove that allows the lid. This will allow for a more organized and keeps all items on the unit rather than sitting next to or taking up space. This allows for a place for the utensil to set above rather than sitting next to the appliance, e.g., crock pot or warmer, and minimize cross contamination between units.

The individual and serving center to allow more efficiency when placing on a countertop, buffet, serving station, bar top or table. This innovation and invention will enhance many consumers abilities to space and time when planning any food preparation. This can be used in all settings personally, commercially, and everything in a between. This new slim and efficient design will allow for this product to be a staple in every household, RV or traveling style living, and commercial kitchen.

Another aspect of the invention is to provide interchangeable or reusable skins or decorative covers for the housing which can be integral or connectable and allows for the outside look to change. The skins can be heat resistant material that can cover the outside of the unit. This allows for you to customize to every event, part or household to match.

### BRIEF DESCRIPTION OF THE DRAWINGS

The accompanying drawings, which are incorporated in and constitute a part of this specification, illustrate one or more embodiments of the invention and, together with the description, help to explain the invention. The drawings are not necessarily to scale, or inclusive of all elements of a system, emphasis instead generally being placed upon illustrating the concepts, structures, and techniques sought to be protected herein.

FIG. 1 is a perspective view of one embodiment of the invention.

FIG. 2 is a side of FIG. 1.

FIG. 3 is a back perspective of FIG. 1.

FIG. 4 is a perspective view of another embodiment of the invention.

FIG. 5 is a side of FIG. 4.

FIG. 6 is a back perspective of FIG. 4.

FIG. 7 is a perspective view of yet one embodiment of the invention.

FIG. 8 is a side of FIG. 7.

FIG. 9 is a perspective view of one embodiment of the invention.

FIG. 10 is a side of FIG. 9.

FIG. 11 is a back perspective of FIG. 9.

FIG. 12 is a perspective view of another embodiment of the invention.

FIG. 13 is a side of FIG. 12.

FIG. 14 is a back perspective of FIG. 12.

FIG. 15 is a bottom view perspective of an appliance in FIG. 12.

FIG. 16 is a perspective view of one embodiment of the invention.

FIG. 17 is a side of FIG. 16.

FIG. 18 is a back perspective of FIG. 16.

FIG. 19 is a perspective view of one embodiment of the invention.

FIG. 20 is a side of FIG. 19.

FIG. 21 is a back perspective of FIG. 19.

FIG. 22 is a perspective view of one embodiment of the invention.

FIG. 23 is a side of FIG. 22.

FIG. 24 is a back perspective of FIG. 22.

FIG. 25 depicts side by side illustration of articulation supports in the invention.

FIG. 26 is a perspective view of one embodiment of the invention.

FIG. 27 is a side of FIG. 26.

FIG. 28 is a back perspective of FIG. 26.

FIG. 29 is a perspective view of one embodiment of the invention.

FIG. 30 is a side of FIG. 29.

FIG. 31 is a back perspective of FIG. 29.

FIG. 32 is a perspective view of one embodiment of the invention.

FIG. 33 is a side of FIG. 32.

FIG. 34 is a back perspective of FIG. 32.

FIG. 35 is a perspective view of one embodiment of the invention.

FIG. 36 is a side of FIG. 35.

FIG. 37 is a back perspective of FIG. 35.

FIG. 38 is a perspective view of one embodiment of the invention.

FIG. 39 is a side of FIG. 38.

FIG. 40 is a back perspective of FIG. 38.

FIG. 41 is a bottom view of an appliance in FIG. 38.

FIG. 42 is a perspective view of one embodiment of the invention.

FIG. 43 is a side of FIG. 42.

FIG. 44 is a back perspective of FIG. 42.

FIG. 45 is a perspective view of one embodiment of the invention.

FIG. 46 is a side of FIG. 45.

FIG. 47 is a back perspective view of FIG. 45.

FIG. 48 is a perspective view of another embodiment of the invention.

FIG. 49 is a side of FIG. 48.

FIG. 50 is a back perspective of another embodiment of the invention.

FIG. 51 a side view of FIG. 50.

FIG. 52 is a back perspective of another embodiment of the invention.

FIG. 53 a side view including the invention of FIG. 52.

FIG. 54 is a front view of another embodiment of the invention in a stored mode.

FIG. 55 is a side view employing the invention in FIG. 54.

FIG. 56 is a front view of FIG. 54 in use mode.

FIG. 57 is a back perspective of another embodiment of the invention.

FIG. 58 a side view of FIG. 57.

FIG. 59 is a side by side illustration of the appliance in FIG. 57.

FIG. 60 depicts a perspective of a preferred embodiment of the invention.

FIG. 61 is a top perspective of FIG. 60.

FIG. 62 depicts a back perspective of FIG. 60.

FIG. 63 is a side perspective of FIG. 60.

FIG. 64 depicts a cutaway perspective of an insert of the invention.

FIG. 65 depicts a perspective of multiple connected appliances of the invention.

FIG. 66 depicts a perspective of a lid part in a housing part of the invention.

FIG. 67 depicts another configuration of multiple connected appliances of the invention.

FIG. 68 depicts an embodiment with interchangeable skin exterior for the appliance of the invention.

### DETAILED DESCRIPTION OF PREFERRED EMBODIMENTS

Embodiments of the presently disclosed smart thermal appliance designated generally by the numeral 10 which may help reduce or eliminate some of the time required for meal preparation and clean up as well as aid in the setup and ergonomic aspects using such items. There are numerous embodiments disclosed herein, and it should be understood that like numerals represent like parts in the embodiments.

The appliance(s) 10, such as a slow cooker (crock pot) as seen in the drawings, includes a housing 12 having an insert 14 operably contained therein for receiving product for human consumption. The housing 12 include an upper a stacking mating surfaces 16 which are in upper surface 17, preferably adjacent a back 18 of the housing 12.

The housing 12 include bottom mating surfaces 20 of bottom surface 22, adjacent a front 24 and back 18 of the housing 12. The bottom mating surfaces 20 complementary configured to be mated to an upper stacking mating surface 16 of another like formed appliance 10 as seen in Figures. A grooved surface 24 is also provided in the upper surface 17 and its use with lid 100 will be apparent hereinafter.

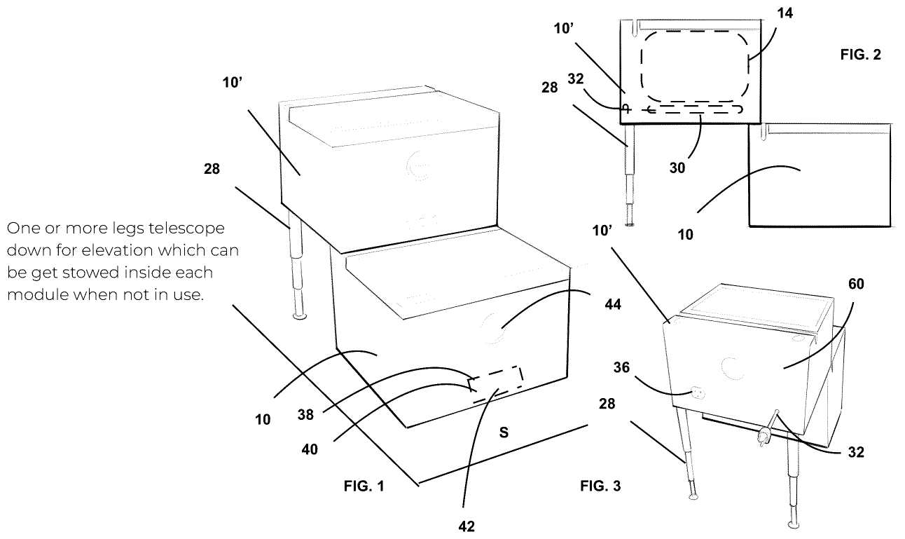

FIGS. 1-3 show an embodiment with independent telescoping stands or legs 28. The legs 28 can be extended to the appropriate height and twist locked in place. The legs can be recessed or otherwise stored adjacent the rear of the housing 12.

As can be seen in FIGS. 1-3, the stands 28 are operably connected to the housing 12 of an upwardly disposed appliance 10 to enable disposal on a ground surface S below when the appliance 10 is mated with another like appliance 10′ to maintain the upwardly disposed appliance 10 in an elevated normal position relative to the stands 28 while enabling proper fitment of the upper stacking mating surface 16 and bottom mating surface 20. The stands 28 can be space saving legs 28 that extend down to allow for the appliance 10 to connect and stack individual appliance(s) 10 to make a buffet or serving station for example.

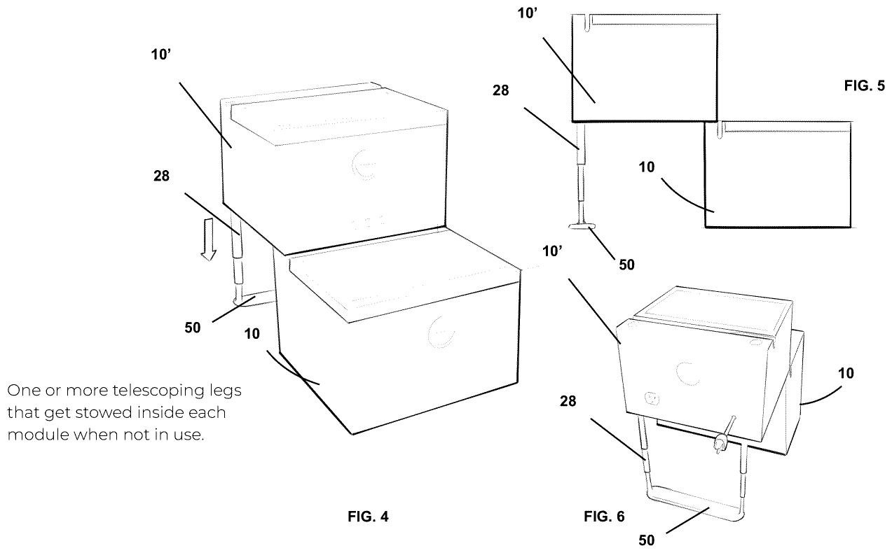

The housing 12 can preferably be equipped with a heating element 30 for heating the insert 14. An electrical power inlet line 32 extends through the housing 12 to power the heating element 32, preferably in a manner which does not impede the interconnect-ability of the appliances (10, 10′), such as in the back 34 of the housing 12. To this end, there is also provided a power outlet 36 disposed on the housing 12 operably connected to the electrical power inlet line 32 for supplying power for example to an adjacent appliance 10′. The housing 12 can also be equipped with a power panel 38 which can have a switch 40 for powering on and off the appliance 10 as well as be provided with on and off power indicator lights 42. Additionally, the housing 12 can be equipped with a visible temperature indicator 44 operably connected to the insert 14 in a manner to display temperature therein. FIGS. 4-6 depict a similar appliance 10′ with legs 28 being interconnected with a foot 50, thus forming an integral structure.

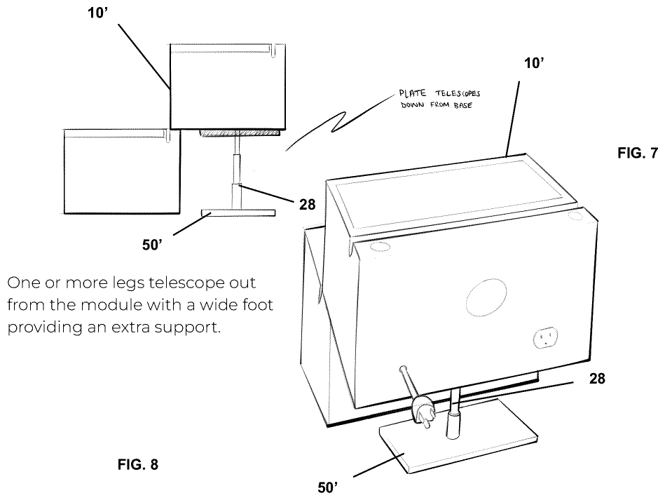

FIGS. 7-8 show a single telescoping stand 28 with a foot 50′.

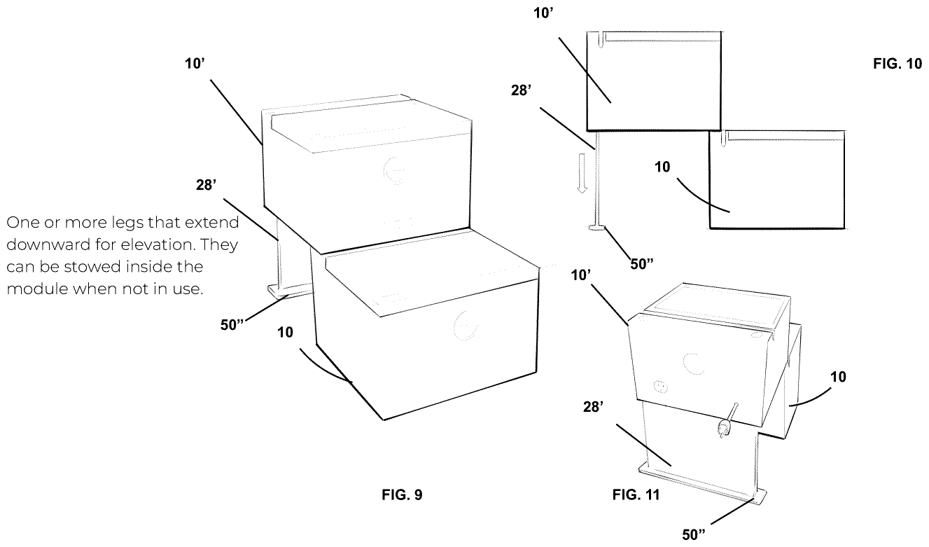

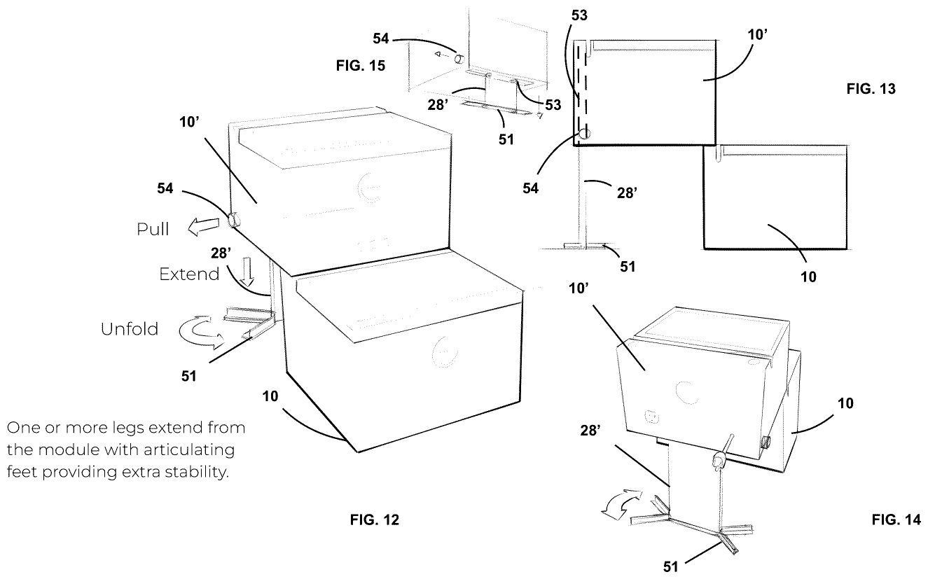

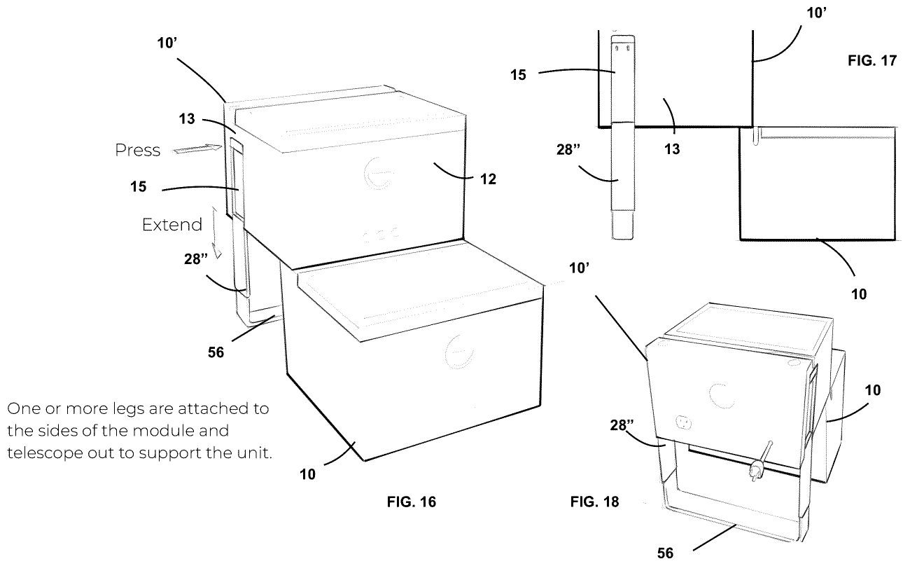

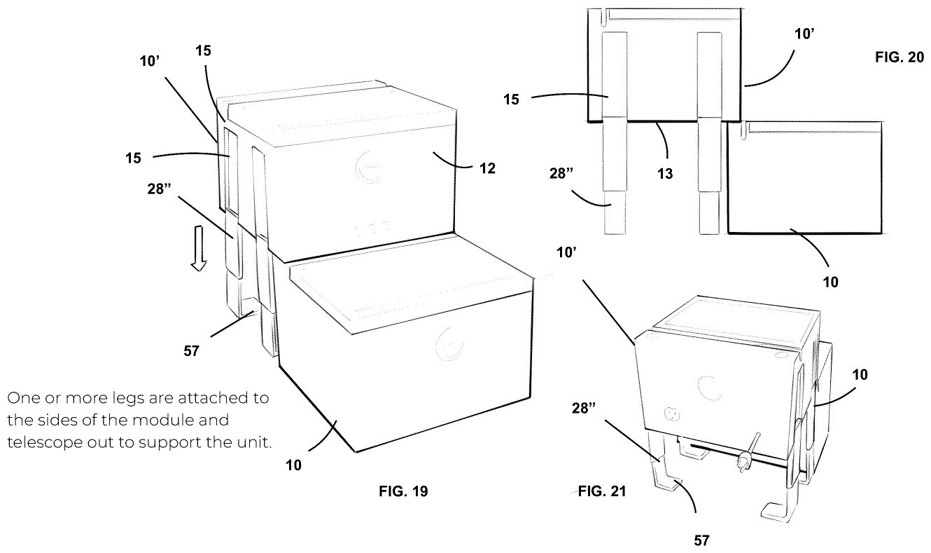

FIGS. 9-11 show another embodiment of a stand 28′ with foot 50″. FIGS. 12-15 show yet another embodiment of extendable stand 28′ with unfoldable feet 51, wherein extendable stand 28′ is slidably contained within housing recessed surfaces 53 and released by actuation of a release mechanism 54. FIGS. 16-18 shows similar stand 28″ slidably connected to recessed side surfaces 15 of sides 13 of housing 12 and which are interconnected by foot 56. FIGS. 19-21 provide stands 28″ slidably connected to sides 13 of housing 12 each with a foot 57.

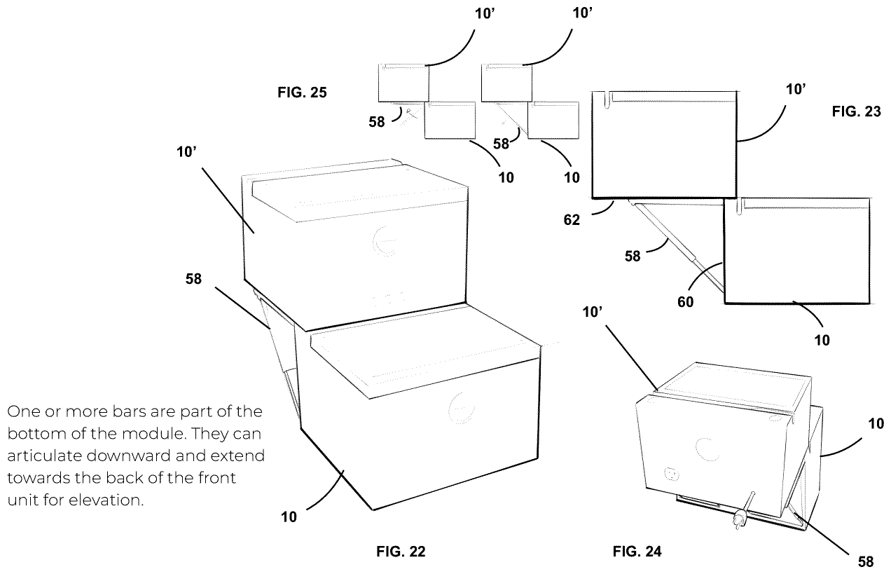

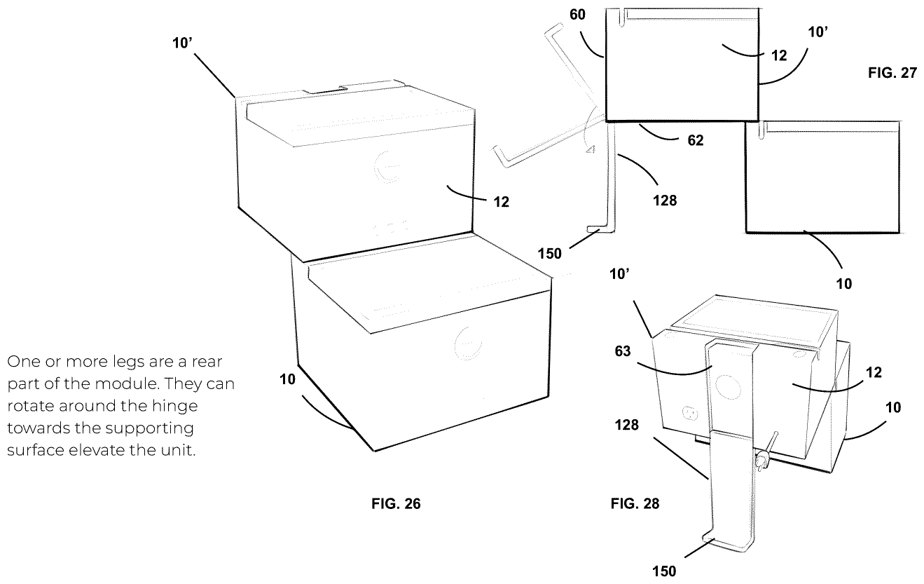

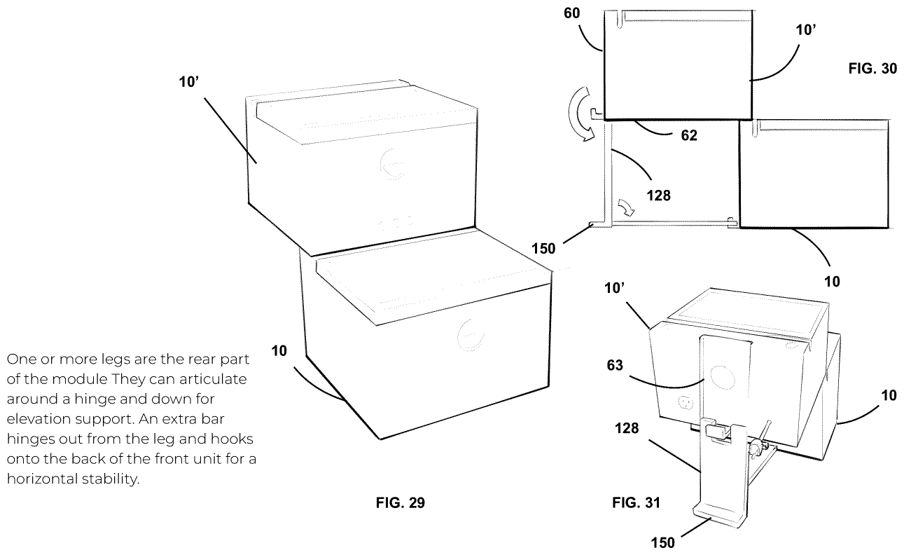

FIGS. 22-25 provide support bars 58 which interconnect a back side 60 of lower appliance 10 with a bottom 62 of an upper disposed appliance 10′. FIGS. 26-28 show a stand 128 which is hinged to back 60 adjacent the bottom 62 of housing 12 and seats in a recess 63 of housing 12 when not in use. A foot 150 extends laterally from the stand 128. FIGS. 29-31 additionally add a support bar brace 60 interconnecting the stand 128 and back 60 of lower housing 12 of appliance 10.

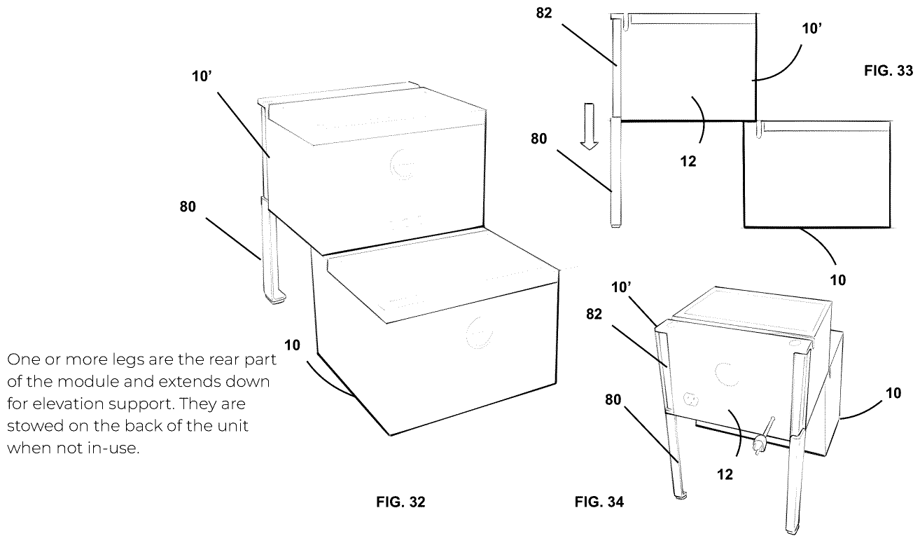

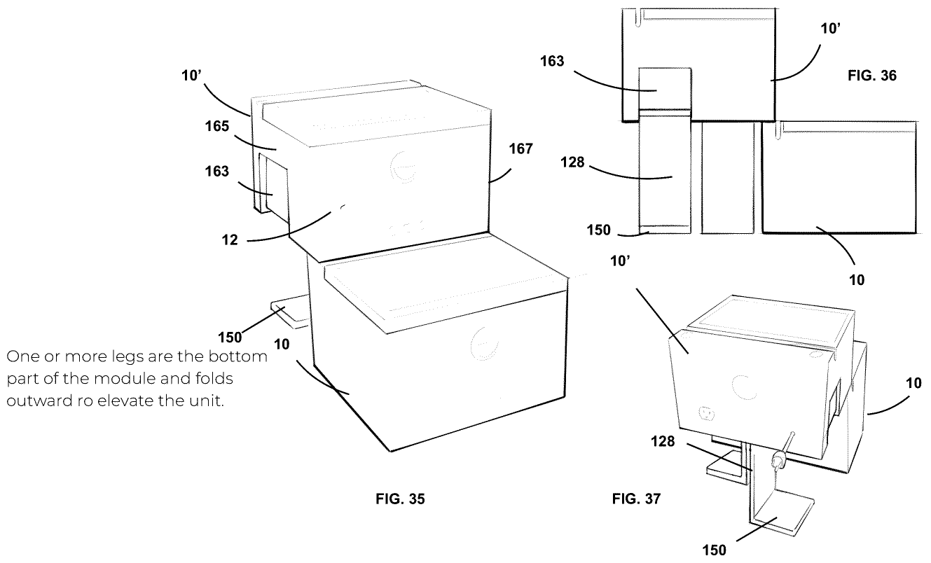

FIGS. 32-34 shows still another embodiment in which legs 80 which are slidably connected to recessed corner surfaces 82 of housing 12. FIGS. 35-37 show stand legs 128 hinged on the bottom 60 in recess 163 of housing 12. Each leg 128 has a foot 150 and are laterally spaced to be received on opposing recesses 163 on opposite sides 165 and 167 of housing 12.

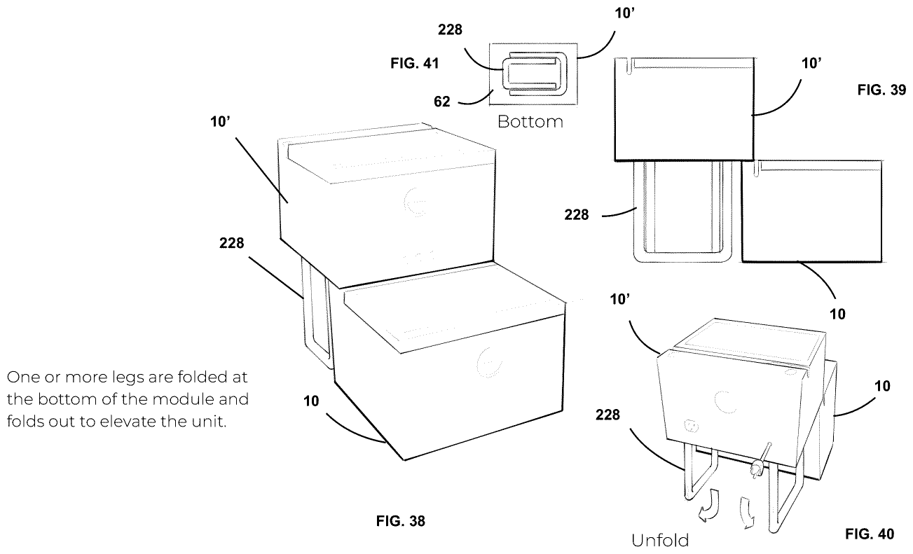

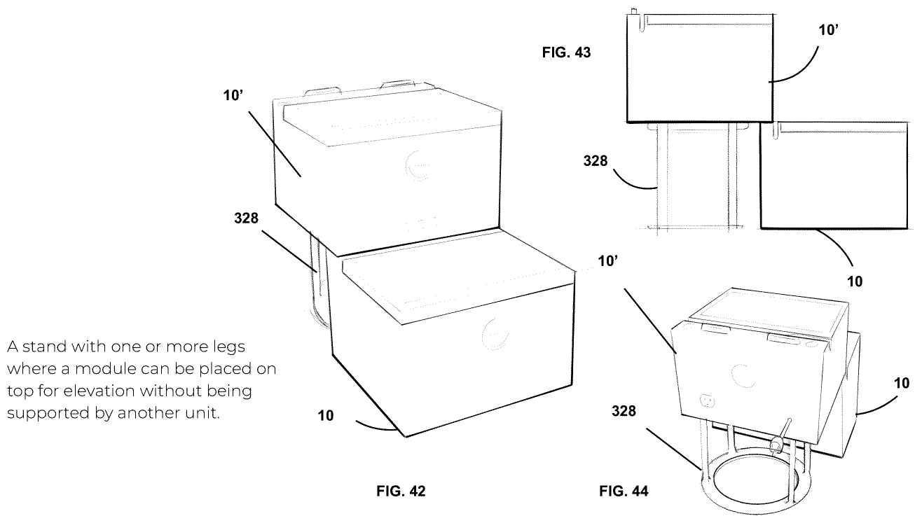

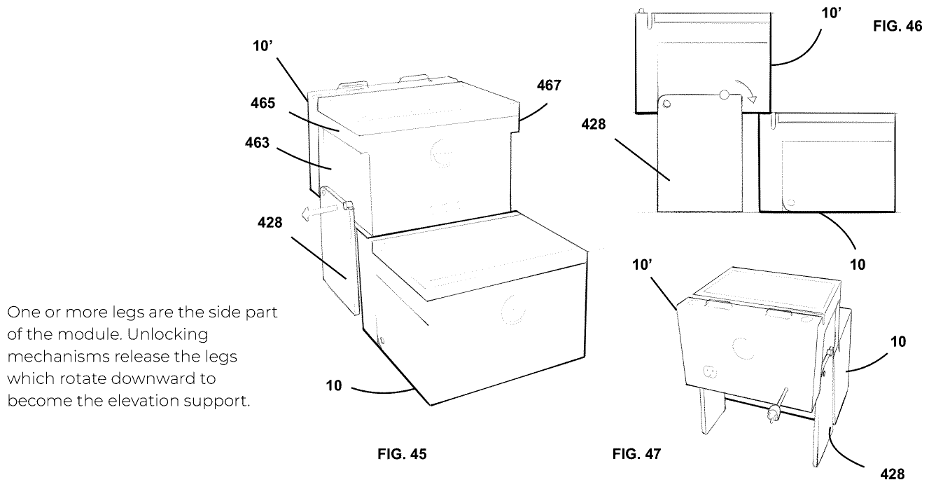

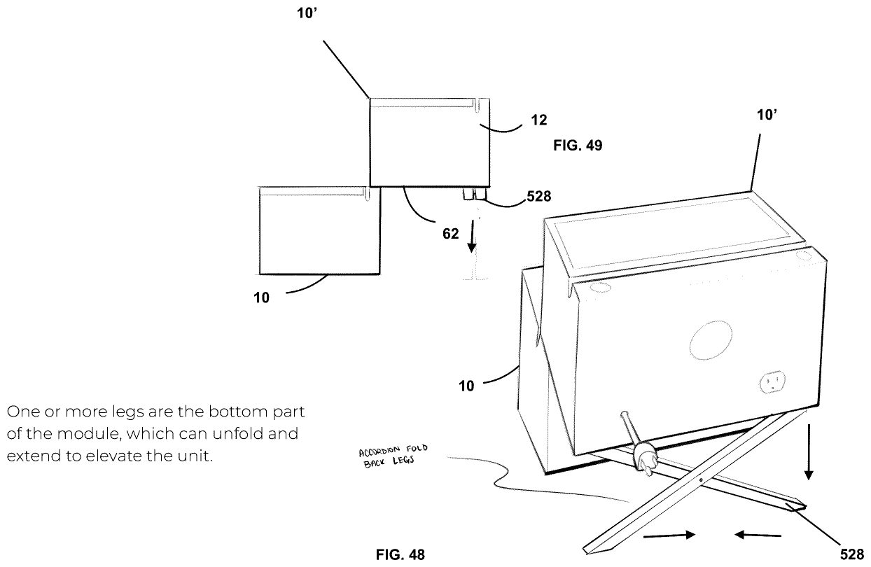

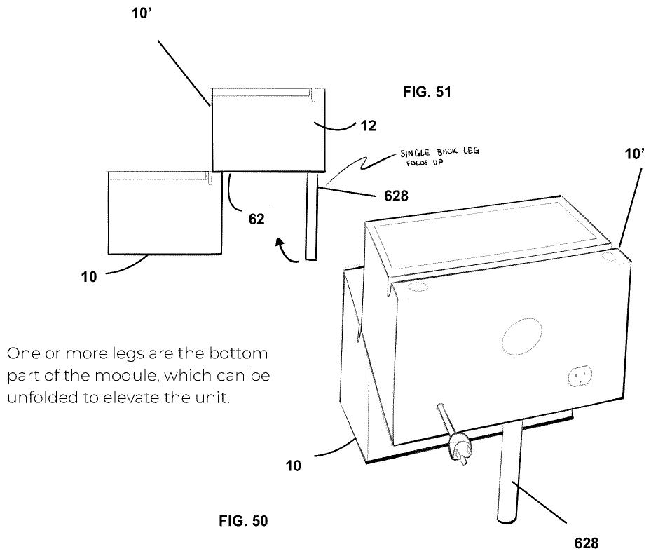

FIGS. 38-41 show folding U shaped stands 228 which are hinged to bottom 62. FIGS. 42-44 show a ring stand 328 for supporting the appliance 10′. FIGS. 45-47 show a stands 428 pivotally connected to a recessed area 463 of sides 465, 467 of housing 12. FIGS. 48-49 show crisscross legs 528 which expand from a bottom 62 of housing 12. FIGS. 50-51 show a folding leg stand 628 connected to bottom 62 of housing 12.

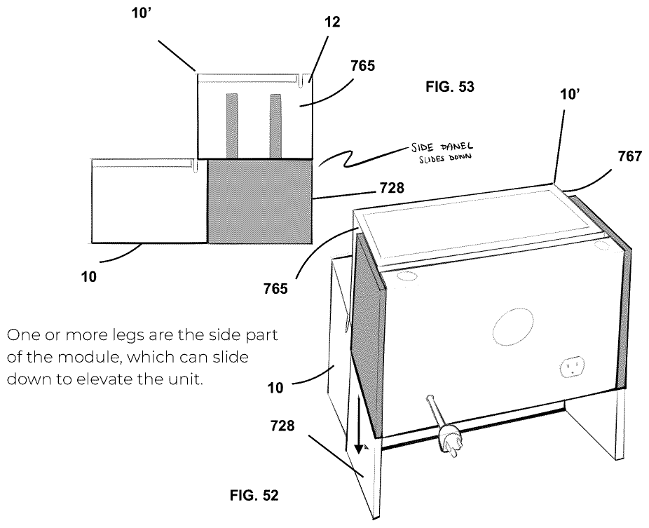

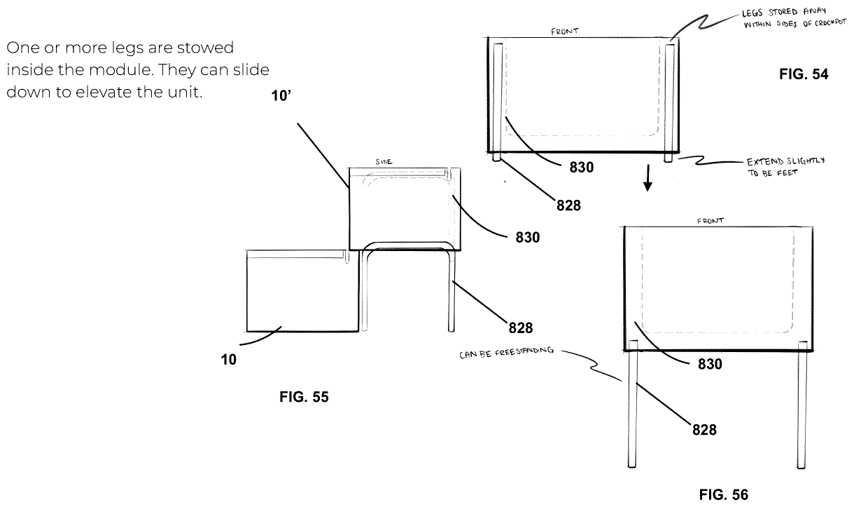

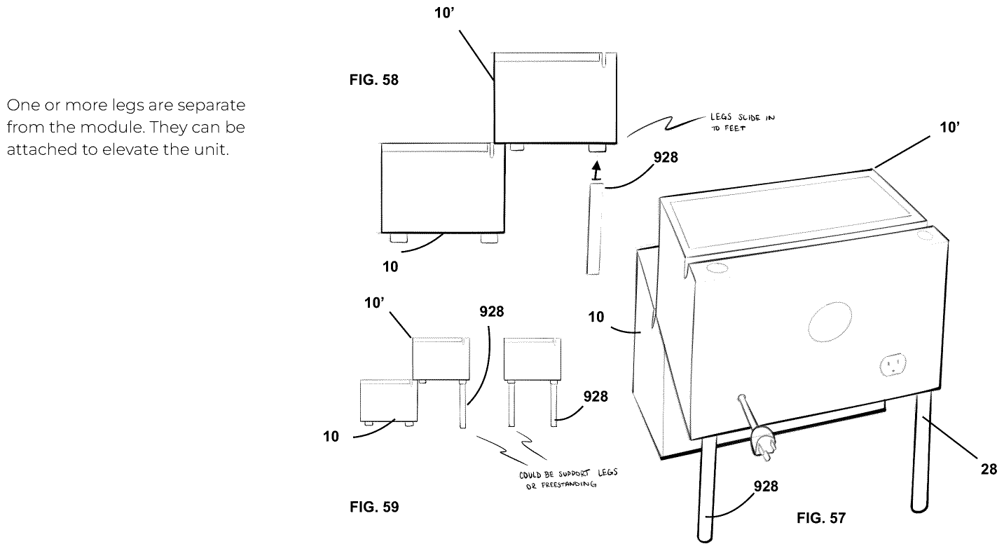

FIGS. 52-53 show sliding stand sides 728 which slidably connect to sides 765, 767 of housing 12. FIGS. 54-56 show stand legs 828 which are slidably contained within openings in the corner recessed surfaces 830 of the housing 12. Another version disclosed in FIGS. 57-59 shows connectable legs 928.

The appliance 10 can be a stackable a square, rectangular design or other geometric shape which lends itself to accomplishing the objectives herein. The appliance 10 can have a height dimension that allows for one or more stands or legs 28, for example, to allow for stacking and linking of the individual appliances 10, 10′ to connect each other.

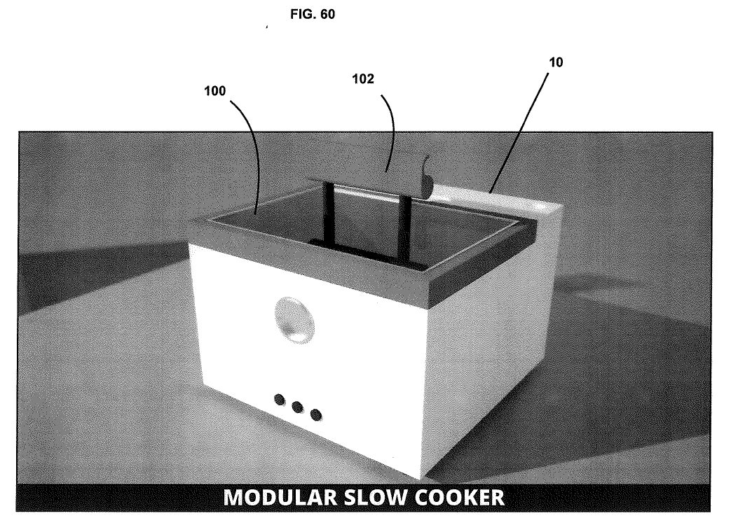

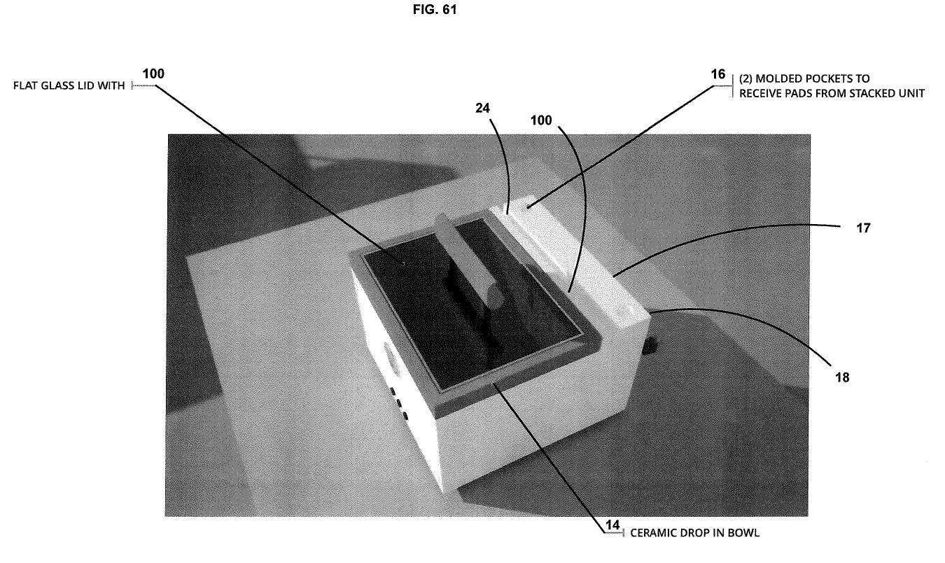

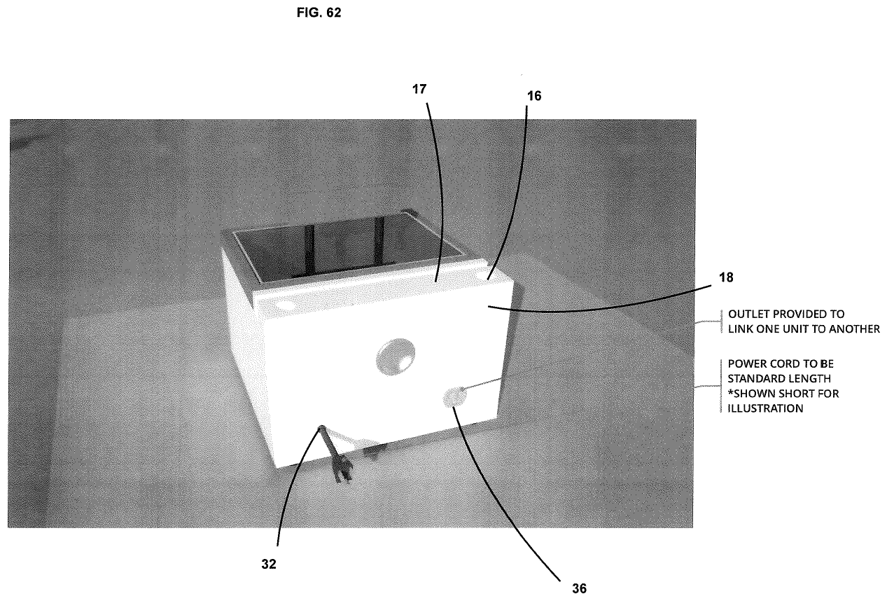

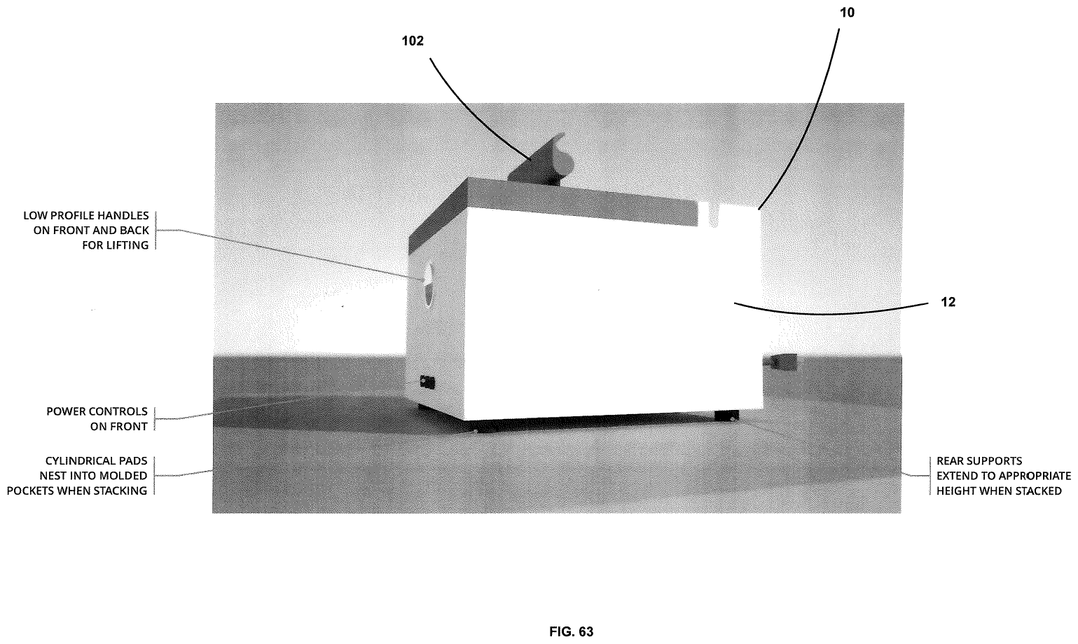

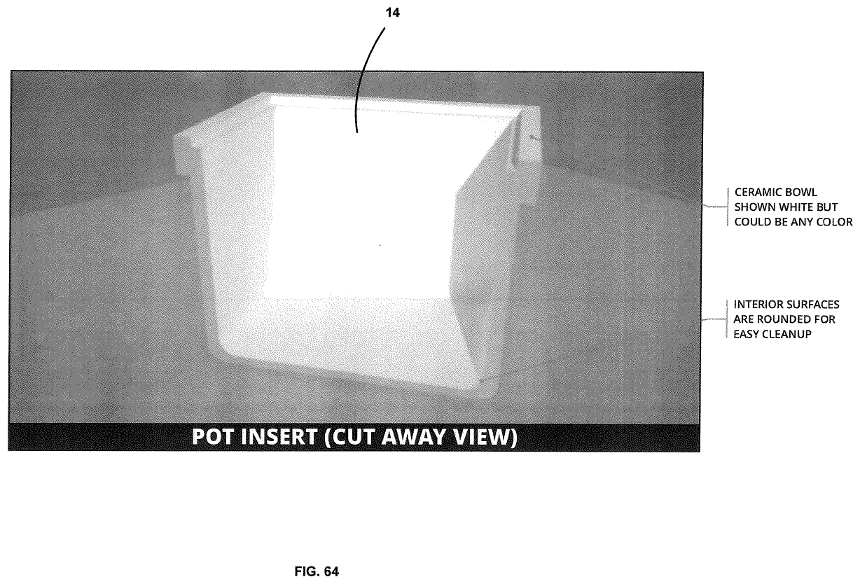

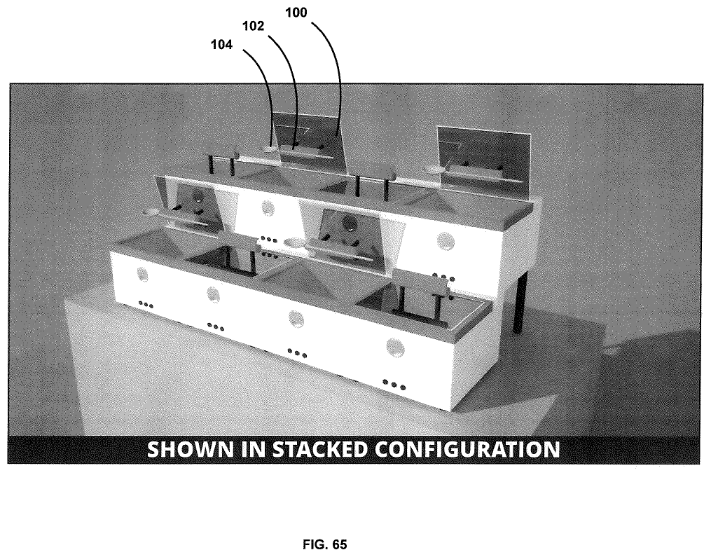

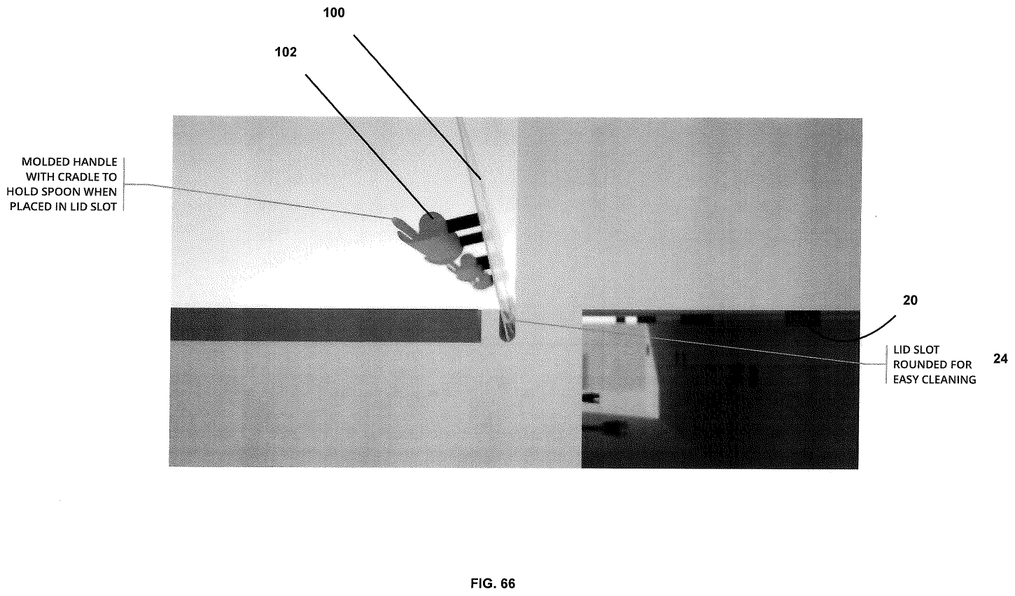

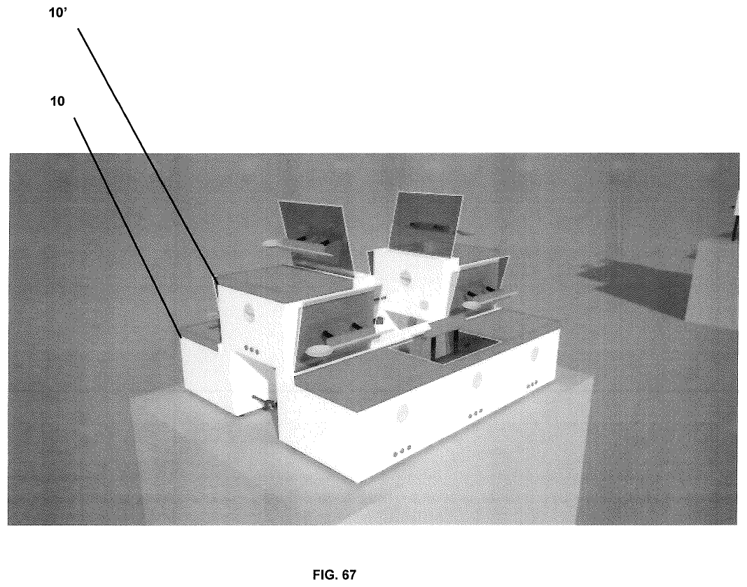

A removable lid 100 as seen in FIGS. 60-69 can preferably be provided to cover insert 14 and fit on top thereof in a complementary manner. The lid 100 can also be equipped with a handle 102 which can preferably have a shape, such as a concave aspect, to aid in retention of a utensil 104, such as a spoon or fork. The lid 100 I can be removable and configured with a thickness to seat in a groove of a portion of an upper groove surface 24 of the housing 12 and when so seated, the handle is positioned to retain the utensil 104. This space saving design includes placement for the lid 100 and spoon 104 to be held on the appliance 10 to save space. The handle 102 serves as both a handle and utensil holder as noted can be configured preferably to fit within groove 24 that allows the lid 100 to stand on its edge. This will allow for organization of all items on the unit rather than sitting next to or taking up space in the proximate area. It also allows a place for the utensil 104 to set above rather than next to the appliance 10, 10′, and minimizes cross contamination between appliances 10, 10′.

The individual and serving center to allow more efficiency when placing on a countertop, buffet, serving station, bar top or table. This innovation and invention will enhance many consumers abilities to space and time when planning any food preparation. This can be used in all settings personally, commercially, and everything in a between. This new slim and efficient design will allow for this product to be a staple in every household, RV or traveling style living, and commercial kitchen.

As illustrated in FIG. 68, another aspect of the invention is to provide interchangeable or reusable skin(s) 110 or decorative covers for the housing 12 which can be integral or connectable and allows for the outside look to change. The skins 110 can be heat resistant material that can cover the outside of the appliance 10. This allows for you to customize to every event, part or household to match.

While the present invention has been described in terms of preferred embodiments, it is apparent that other forms could be adopted by one skilled in the art. In other words, the teachings of the present invention encompass any reasonable substitution or equivalents of the claim limitations. Accordingly, the scope of the present invention is not to be limited by the embodiments disclosed, and invention is entitled to the scope of the following claims.

What is claimed:

1. A thermal appliance, which includes:
a housing having an insert operably contained therein for receiving product for human consumption, said housing having an upper a stacking mating surface, a bottom mating surface complementary configured to be mated to an upper stacking mating surface of another like formed appliance; and
a stand operably connected to said housing of said upwardly disposed appliance and to enable disposal on a surface below when said appliance is mated with another like appliance to maintain said upwardly disposed appliance in an elevated normal position relative to said stand.

2. The thermal appliance of claim 1, wherein said upper a stacking mating surface is adjacent a back of said housing of said appliance and said bottom mating surface is adjacent a front of said housing.

3. The thermal appliance of claim 1, wherein said housing is equipped with a heating element for heating said insert.

4. The thermal appliance of claim 3, which includes an electrical power inlet line which extends through said housing to power said heating element in a manner which does not impede the interconnect-ability of the appliances.

5. The thermal appliance of claim 4, which includes a power outlet disposed on the housing operably connected to said electrical power inlet line for supplying power to another adjacent appliance.

6. The thermal appliance of claim 1, wherein said housing is equipped with a power panel having a switch for powering on and off and on/off power indicator lights.

7. The thermal appliance of claim 1, wherein said housing is equipped with a visible temperature indicator operably connected to said insert in a manner to display temperature therein.

8. The thermal appliance of claim 1, which includes a removable lid configured to cover said insert in a complementary manner.

9. The thermal appliance of claim 8, wherein said lid is equipped with a handle which has a concave aspect to aid in retention of a utensil.

10. The thermal appliance of claim 8, wherein said lid is configured with a thickness to seat in a groove of a portion of an upper surface of said housing.

11. The thermal appliance of claim 9, wherein said lid is configured with a thickness to seat in a groove of a portion of an upper surface of said housing and when so seated said handle is positioned with said concave aspect upward to retain a utensil.

12. The thermal appliance of claim 1, which includes interchangeable skin cover connected to said housing.

13. The thermal appliance of claim 12, wherein said skin cover is reusable.

14. The thermal appliance of claim 12, wherein said skin cover is a heat resistant material.
